(19) United States
(12) Patent Application Publication
(10) Pub. No.: US 2021/0295267 A1
(43) Pub. Date: Sep. 23, 2021

(54) INFORMATION PROCESSING APPARATUS AND NON-TRANSITORY COMPUTER READABLE MEDIUM

(71) Applicant: FUJIFILM Business Innovation Corp., Tokyo (JP)

(72) Inventors: Takuma SUZUKI, Kanagawa (JP); Kenji MIYATA, Kanagawa (JP); Takashi MORIMURA, Kanagawa (JP)

(73) Assignee: FUJIFILM Business Innovation Corp., Tokyo (JP)

(21) Appl. No.: 17/015,090

(22) Filed: Sep. 9, 2020

(30) Foreign Application Priority Data
Mar. 17, 2020 (JP) 2020-047035

(51) Int. Cl. G06Q 10/10; G06Q 30/06; G06Q 10/06; G06Q 50/04; G06Q 30/02; G06F 3/12

(52) U.S. Cl. CPC G06Q 10/103; G06Q 30/0637; G06Q 10/06315; G06F 3/126; G06Q 30/0283; G06F 3/1203; G06F 3/1275; G06Q 50/04

(57) ABSTRACT

An information processing apparatus includes a processor. The processor is configured to store received-order information indicating that production of printed matter is acceptable and containing device information used for producing the printed matter, accept order information with respect to a process for producing the printed matter, identify the received-order information indicating that the production of the printed matter is acceptable from the stored received-order information by using the printed matter indicated in the order information as a search condition, and associate the order information with at least one device corresponding to the device information associated with the identified received-order information.

### CROSS-REFERENCE TO RELATED APPLICATIONS

This application is based on and claims priority under 35 USC 119 from Japanese Patent Application No. 2020-047035 filed Mar. 17, 2020.

### BACKGROUND

### (i) Technical Field

The present disclosure relates to information processing apparatuses and non-transitory computer readable media.

### (ii) Related Art

Japanese Patent No. 4940787 discloses a printed-matter order placing-receiving apparatus that establishes a workflow for producing printed matter from multiple steps based on a condition from a user and that receives an order for the production of the printed matter from the user. The printed-matter order placing-receiving apparatus includes a registration unit, a workflow creating unit, a first step-searching unit, a second step-searching unit, a workflow establishing unit, an estimate calculating unit, an estimate presenting unit, an order receiving unit, and a production commanding unit. The registration unit registers therein a step definition including performance information and step information for each of steps serving as basic units when each of multiple order receivers produces the printed matter. Based on a printed-matter production condition including multiple conditions requested from the user, the workflow creating unit creates a first workflow in which steps compatible with the production condition are linked in accordance with a processing sequence compatible with the production condition. The first step-searching unit searches through the registration unit for a step definition compatible with the steps included in the first workflow created by the workflow creating unit. The second step-searching unit searches through the registration unit for a step definition compatible with similar conditions having one or two different conditions from among the multiple conditions included in the production condition. The workflow establishing unit links the step definition retrieved by the first step-searching unit and the step definition retrieved by the second step-searching unit in accordance with a sequence corresponding to the steps included in the first workflow created by the workflow creating unit, and establishes a second workflow that allows step definitions to be selectable if multiple step definitions are compatible with the steps. The estimate calculating unit calculates the cost to be used for producing the printed matter based on the second workflow established by the workflow establishing unit for each of freely-selected step definitions of the second workflow. The estimate presenting unit presents, to the user, the second workflow established by the workflow establishing unit together with the cost calculated by the estimate calculating unit. The order receiving unit receives an order for the production of the printed matter in accordance with the second workflow presented by the estimate presenting unit and a step definition selected by the user from the second workflow. The production commanding unit commands the corresponding order receivers to execute the steps included in the second workflow for which the order is received by the order receiving unit.

### SUMMARY

In the printing industry, a process for producing printed matter is sometimes performed by multiple companies by dividing the process into steps, allocating orders for the divided steps to different companies, and allowing the companies to receive the orders and execute the divided steps. In order to efficiently manage the process for producing the printed matter among the multiple companies, there is a technique for establishing a workflow of the process among the multiple companies.

However, when an order is to be placed and received for the process of producing the printed matter, the throughput of the process and the compatibility with the operational status of each company have to be checked between the orderer and the order receiver, sometimes resulting in increased workload for checking the throughput of the process and the operational status of each company.

Aspects of non-limiting embodiments of the present disclosure relate to an information processing apparatus and a non-transitory computer readable medium that may allow for reduced workload involved in checking the throughput of a process for producing printed matter and the operational status of each company when an order is placed and received for each step of the process, as compared with a case where the throughput of the process and the operational status of each company are checked between the orderer and the order receiver.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a processor. The processor is configured to store received-order information indicating that production of printed matter is acceptable and containing device information used for producing the printed matter, accept order information with respect to a process for producing the printed matter, identify the received-order information indicating that the production of the printed matter is acceptable from the stored received-order information by using the printed matter indicated in the order information as a search condition, and associate the order information with at least one device corresponding to the device information associated with the identified received-order information.

### BRIEF DESCRIPTION OF THE DRAWINGS

Exemplary embodiments of the present disclosure will be described in detail based on the following figures, wherein:

FIG. 1 is a block diagram illustrating an example of the configuration of a printed-matter order placing-receiving system according to an exemplary embodiment;

FIG. 2 is a use case diagram illustrating an example of functions of the printed-matter order placing-receiving system according to this exemplary embodiment;

FIG. 3 is a block diagram illustrating an example of a hardware configuration of a printed-matter order placing-receiving server according to this exemplary embodiment;

FIG. 4 is a block diagram illustrating an example of a functional configuration of the printed-matter order placing-receiving server according to this exemplary embodiment;

FIG. 5 is an entity relationship diagram illustrating an example of the relationship among pieces of information according to this exemplary embodiment;

FIG. 6 illustrates an example of authority levels of the printed-matter order placing-receiving server according to this exemplary embodiment;

FIG. 7 is a sequence diagram illustrating an example of the flow of an order receiving process in the printed-matter order placing-receiving system according to this exemplary embodiment;

FIG. 8 is a sequence diagram illustrating an example of the flow of an ordering process in the printed-matter order placing-receiving system according to this exemplary embodiment;

FIG. 9 schematically illustrates an example of a screen that displays an operational status of the printed-matter order placing-receiving server according to this exemplary embodiment;

FIG. 10 schematically illustrates an example of a screen used for registering order information in the printed-matter order placing-receiving server according to this exemplary embodiment;

FIG. 11 schematically illustrates an example of a screen used for searching for order information in the printed-matter order placing-receiving server according to this exemplary embodiment;

FIG. 12 schematically illustrates an example of a screen used for registering received-order information in the printed-matter order placing-receiving server according to this exemplary embodiment;

FIG. 13 schematically illustrates an example of a screen used for searching for received-order information in the printed-matter order placing-receiving server according to this exemplary embodiment;

FIG. 14 is a flowchart illustrating an example of information processing according to this exemplary embodiment;

FIG. 15 is a flowchart illustrating an example of a registration process according to this exemplary embodiment;

FIG. 16 is a flowchart illustrating an example of an order-receiver searching process according to this exemplary embodiment; and

FIG. 17 is a flowchart illustrating an example of an order searching process according to this exemplary embodiment.

### DETAILED DESCRIPTION

Exemplary embodiments of the present disclosure will be described in detail below with reference to the drawings. The following embodiments relate to, but are not limited to, a case where information input to and transmitted from a terminal is acquired and processed by a server as an information processing apparatus. Alternatively, for example, instead of being a server, the information processing apparatus may exhibit its function by using an apparatus, such as a personal computer or a tablet terminal, or may function entirely as an information processing system that uses an information processing apparatus and a terminal apparatus.

Furthermore, as an alternative to a process executed by acquiring information transmitted from another terminal apparatus, the information may be input by directly operating the information processing apparatus and may be processed by the information processing apparatus.

The following description relates to a case where the information processing apparatus according to this exemplary embodiment is a printed-matter order placing-receiving server that acquires and manages information related to an order placed and received from user terminals.

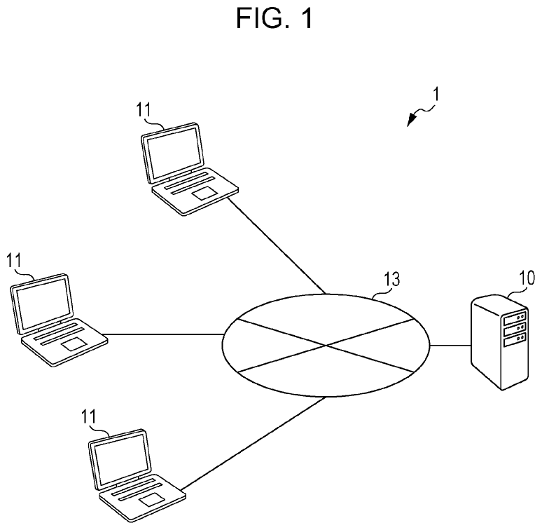

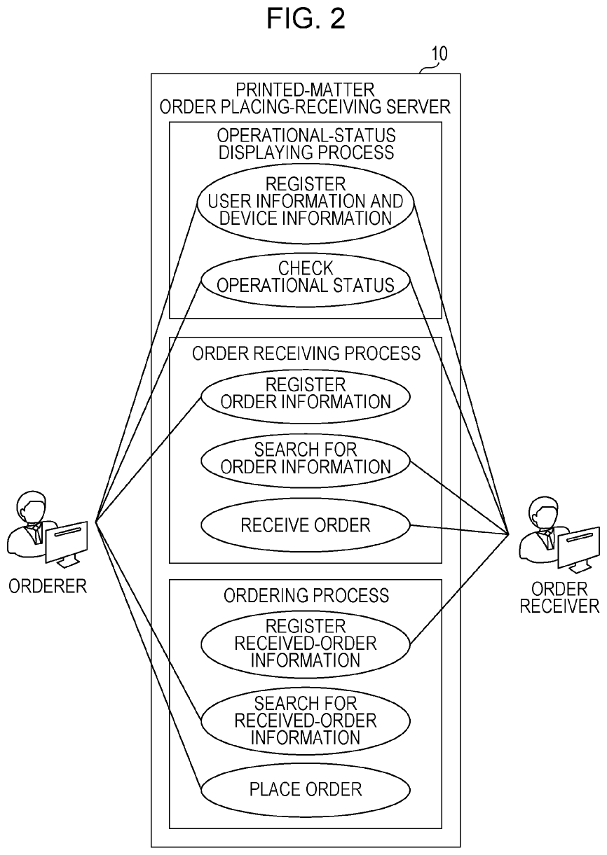

The configuration and the function of a printed-matter order placing-receiving system 1 will now be described with reference to FIGS. 1 and 2. FIG. 1 is a block diagram illustrating an example of the configuration of the printed-matter order placing-receiving system 1 according to this exemplary embodiment.

As shown in FIG. 1, the printed-matter order placing-receiving system 1 includes a printed-matter order placing-receiving server 10 and terminals 11. The printed-matter order placing-receiving server 10 and each terminal 11 are connected to each other by using a communication line 13. The printed-matter order placing-receiving system 1 according to this exemplary embodiment may be used as a system for placing or receiving an order for printed matter. A user placing an order for the printed matter (i.e., an orderer) and a user receiving the order for the printed matter (i.e., an order receiver) operate the corresponding terminals 11 to access the printed-matter order placing-receiving server 10, so as to use the printed-matter order placing-receiving system 1. In the description of the following exemplary embodiment, a terminal 11 operated by an orderer may be referred to as “orderer's terminal”, and a terminal 11 operated by an order receiver may be referred to as “order-receiver's terminal”. The printed-matter order placing-receiving server 10 according to this exemplary embodiment is an example of an information processing apparatus.

FIG. 2 is a use case diagram illustrating an example of functions of the printed-matter order placing-receiving system 1 according to this exemplary embodiment. The printed-matter order placing-receiving server 10 is connected to a network and is communicable with the terminals 11 via the network. In order to accept and process orders of printed matter received and placed from the terminals 11 operated by the corresponding users, the printed-matter order placing-receiving server 10 executes processes, such as an operational-status displaying process, an order receiving process, and an ordering process, as shown in FIG. 2.

In the order receiving process executed in the printed-matter order placing-receiving system 1 according to this exemplary embodiment, a user (i.e., an orderer) who desires to order printed matter preliminarily registers, in the printed-matter order placing-receiving server 10, information (i.e., order information) related to the order for the desired printed matter to be produced. A user (i.e., an order receiver) who desires to receive the order for the printed matter, such as a printing company, searches through the registered information related to the order for the printed matter by designating conditions of printed matter producible by the company, so as to extract the order for the relevant printed matter, thereby undertaking the production of the printed matter for which the order is received.

In the case of the ordering process, the order receiver, such as a printing company, operates the corresponding terminal 11 to preliminarily register, in the printed-matter order placing-receiving server 10, information (i.e., received-order information) related to printed matter producible by the company. The orderer uses the corresponding terminal 11 to search through the registered received-order information by inputting print conditions of printed matter to be ordered for production, so as to retrieve the order receiver, that is, the printing company, capable of producing the desired printed matter and to place the order for the printed matter to the company.

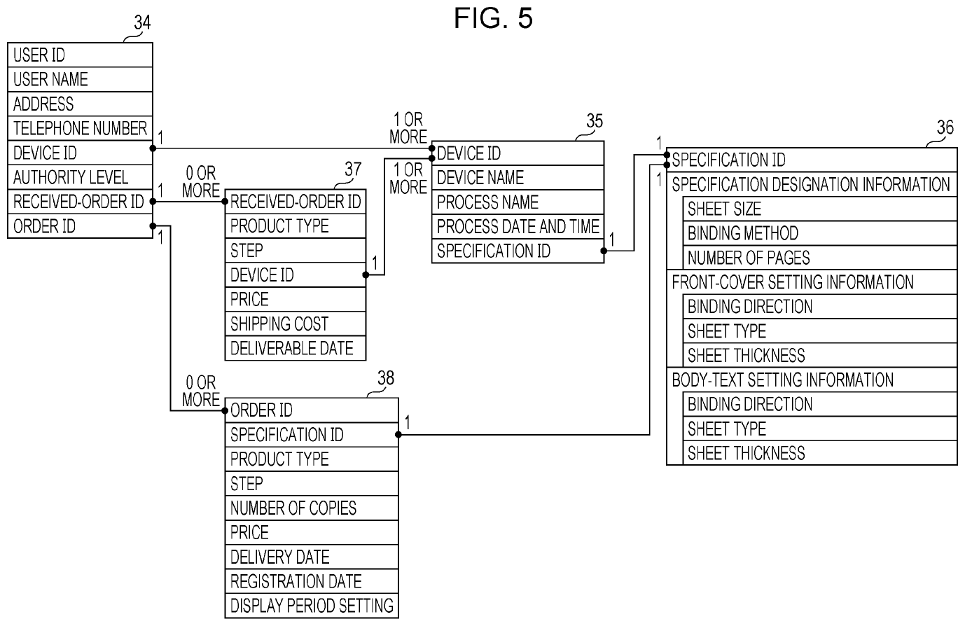

The configuration of the order information and the received-order information used in the order receiving process and the ordering process will be described in detail later with reference to FIG. 5.

If the orderer has a desired delivery date for obtaining the printed matter when ordering the printed matter, the orderer has to place the order to the printing company that may be capable of completing the production of the printed matter before or on the desired delivery date, while ascertaining the operational status of, for example, a printer owned by the printing company. In contrast, in a case where the printing company accepts production of new printed matter (i.e., in the case of the order receiving process), the printing company has to extract an order for printed matter completely producible within the delivery date and receive the order while ascertaining the operational status of each device, such as the printer, owned by the company. Therefore, the operational-status displaying process shown in FIG. 2 involves acquiring the operational status of each of printed-matter production devices, such as the printer and a post-processing device, owned by the printing company and presenting the operational status of each device to users serving as an order receiver and an orderer. The operational status of each device includes the schedule of the device, such as the printer or the post-processing device, used in each step for producing the printed matter, and the operating rate of the device calculated based on the schedule. The operating rate may be calculated for each device based on a percentage occupied by a time frame to which execution of a process is already allocated within a certain period (e.g., a predetermined fixed period, such as one day, one week, or one month). For example, if the device is a printer, the time frame to which execution of a process is allocated may include not only a predicted time period actually required for printing an image onto a sheet as a schedule of the printer for a printing step, but also a time period required for preparation for the printing step and time periods required before and after the printing step, such as changing of trays after the end of the printing step. In a case of a device that performs cutting or binding of printed sheets as post-processing, the aforementioned time frame may include not only a predicted time period required for performing the process, such as the cutting process or the binding process, but also time periods required for preparation and changing of trays before and after the process, such as a time period for setting sheets and a time period after the process.

The flow and the contents of the order receiving process and the ordering process for producing printed matter, as well as a process related to registration of, for example, user information and device information for placing and receiving an order will be described in detail later.

For example, the order receiver and the orderer may operate the corresponding terminals 11 to access the printed-matter order placing-receiving server 10 and may each register information required for receiving or placing an order for production of printed matter. For example, as the user information for using the printed-matter order placing-receiving system 1 described as an example in this exemplary embodiment, information related to the order receiver and the orderer as well as device information of, for example, the printer and the processing device owned by the order receiver and the orderer may be registered. The user information is user-related information required for using the system and may include, for example, the usernames of the order receiver and the orderer (such as the usernames of personal users and the corporate name of the printing company) and contact-related information of each user (such as the address, telephone number, and electronic mail address). If a user may be an order receiver, such as a printing company, receiving an order for production of printed matter, device information of a device owned by the relevant user may be included in the user information. Device-related information (i.e., device information) is used for executing a process for producing printed matter and may include, for example, information about a device name, a process executable by a device, and processing conditions, as information related to a printer or a post-processing device (such as a cutting device, a binding device, or a folding device). The configuration of the user information and the device information will be described in detail later with reference to FIG. 5.

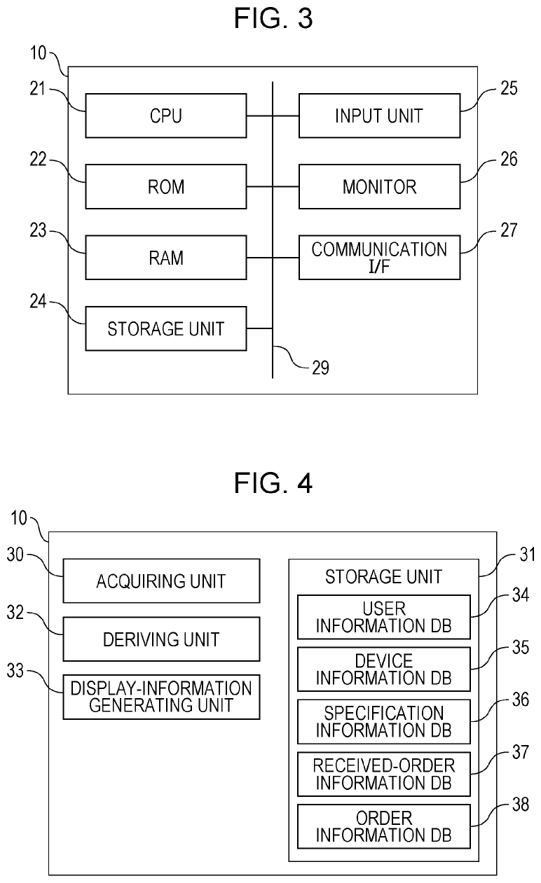

Next, a hardware configuration of the printed-matter order placing-receiving server 10 will be described with reference to FIG. 3. FIG. 3 is a block diagram illustrating an example of the hardware configuration of the printed-matter order placing-receiving server 10 according to this exemplary embodiment. As shown in FIG. 3, the printed-matter order placing-receiving server 10 according to this exemplary embodiment includes a central processing unit (CPU) 21, a read only memory (ROM) 22, a random access memory (RAM) 23, a storage unit 24, an input unit 25, a monitor 26, and a communication interface (communication I/F) 27. The CPU 21, the ROM 22, the RAM 23, the storage unit 24, the input unit 25, the monitor 26, and the communication I/F 27 are connected to one another by using a bus 29. The CPU 21 is an example of a processor.

The CPU 21 comprehensively controls the entire printed-matter order placing-receiving server 10. The ROM 22 has stored therein, for example, data and various types of programs including an information processing program to be used in this exemplary embodiment for placing and receiving an order for printed matter. The RAM 23 is a memory used as a work area when the various types of programs are executed. The CPU 21 executes a program stored in the ROM 22 by expanding the program in the RAM 23, thereby performing control for transmitting the operating rate and the schedule of each device in response to an acquisition request from any of the terminals 11. The storage unit 24 is, for example, a hard disk drive (HDD), a solid state drive (SSD), or a flash memory. The storage unit 24 may have stored therein an information processing program and various types of information. The input unit 25 is a mouse and a keyboard used for inputting, for example, text. The monitor 26 displays, for example, image data and text. The communication I/F 27 communicates with each terminal 11 to exchange data therewith.

Next, a functional configuration of the printed-matter order placing-receiving server 10 will be described with reference to FIG. 4. FIG. 4 is a block diagram illustrating an example of the functional configuration of the printed-matter order placing-receiving server 10 according to this exemplary embodiment.

As shown in FIG. 4, the printed-matter order placing-receiving server 10 has an acquiring unit 30, a storage unit 31, a deriving unit 32, and a display-information generating unit 33. The CPU 21 executes the information processing program so as to function as the acquiring unit 30, the storage unit 31, the deriving unit 32, and the display-information generating unit 33.

The printed-matter order placing-receiving server 10 receives information transmitted from the terminals operated by the users, such as information registered by a user as well as order information and received-order information in the order receiving process and the ordering process, and transmits information managed by the printed-matter order placing-receiving server 10 to the terminals.

When the order receiving process, the ordering process, and the operational-status displaying process are to be executed, the acquiring unit 30 acquires various types of information required for the processes. For example, when user information and device information are to be registered in the system by a user or when order information and received-order information are to be registered in the system in the order receiving process and the ordering process, the acquiring unit 30 acquires these pieces of information set using the terminals 11 by receiving the pieces of information from the network via the communication I/F 27. When a user searches for, for example, an order corresponding to a desired condition or the operational status of a printer, the acquiring unit 30 acquires the information by receiving a search condition from the corresponding terminal 11. Furthermore, when the searching process is to be executed, the acquiring unit 30 acquires information compatible with the condition from information registered in the storage unit 31.

The storage unit 31 stores the information acquired by the acquiring unit 30 via the communication I/F 27, such as the user information, the device information, the information related to the specifications (referred to as “specification information” hereinafter) of the printed matter and the printer, the received-order information, and the order information. When these pieces of information are to be stored, databases for managing the individual pieces of information may be prepared, and each piece of information may be stored in the corresponding database. For example, in this exemplary embodiment, it is assumed that these pieces of information are stored as a user information database (referred to as “DB” hereinafter) 34, a device information DB 35, a specification information DB 36, a received-order information DB 37, and an order information DB 38. For example, FIG. 5 illustrates the configurations of the user information DB 34, the device information DB 35, the specification information DB 36, the received-order information DB 37, and the order information DB 38, as well as the relationship among these databases.

FIG. 5 is an entity relationship diagram illustrating an example of the relationship among the pieces of information according to this exemplary embodiment. As shown in FIG. 5, the storage unit 31 has stored therein the user information DB 34, the device information DB 35, the specification information DB 36, the received-order information DB 37, and the order information DB 38.

The user information DB 34 according to this exemplary embodiment stores and manages information about users (such as an order receiver and an orderer) using the printed-matter order placing-receiving system 1 according to this exemplary embodiment. Each piece of user information includes, for example, a user ID, a user name, an address, contact information, a device ID, an authority level, a received-order ID, and an order ID. A user ID is information based on which a user as an orderer or an order receiver is uniquely identifiable. A user name is a name registered by an orderer or an order receiver. An address is an address of an orderer or an order receiver. Contact information is used for contacting a user, such as an electronic mail address or telephone number of an orderer or an order receiver. A device ID is information based on which a device usable for producing printed matter is uniquely identifiable, and may be managed separately for each type of device, such as a printer, a cutting device, or a folding device. An authority level indicates the level of authority given to each user for accessing information. With regard to the authority level, for example, each user may have one level and may be permitted to or prohibited from browsing a device status in accordance with the user's authority level. Alternatively, an authority level for each device may be set for each user. In that case, more detailed control is possible for permitting or prohibiting each user to or from accessing information about a certain device. A received-order ID is information based on which received-order information registered by a user who desires to receive an order for production of printed matter is uniquely identifiable. An order ID is information based on which order information registered by an orderer is uniquely identifiable.

The device information DB 35 is a database that stores and manages information related to a device used for producing printed matter. Each piece of device information includes, for example, a device ID, a device name, a process name, a process date and time, and a specification ID. A device ID is information based on which a device used for producing printed matter, such as a printer or a post-processing device, is uniquely identifiable. A device name is the name of a printer or a post-processing device and may be, for example, a model name as information from which a user may readily ascertain the type of device when performing the ordering process or the order receiving process. A process name is the name of a process for producing printed matter. A process date and time is the date and time of execution of a process for producing printed matter. A specification ID is information based on which printing conditions and post-processing conditions for printed matter to be produced by using the device are uniquely identifiable.

The specification information DB 36 is a database that stores and manages specification information of printed matter to be produced. Each piece of specification information includes, for example, a specification ID, specification designation information, front-cover setting information, and body-text setting information.

Specification designation information is related to all specifications of printed matter to be produced and includes a sheet size, a binding method, and the number of pages. In this case, the sheet size is the size of a sheet or sheets to be used for the printed matter, the binding method is the method of how the printed matter is bound, and the number of pages is the number of pages forming the printed matter. Printed matter may sometimes be formed of several parts called components, such as a front cover and body text. In such a case, information defining the specifications and processing conditions is sometimes prepared for each component and used for producing the printed matter. In the case of this exemplary embodiment, the printed matter has a front cover and body text as representative components thereof. In that case, the front-cover setting information includes a binding direction, a sheet type, and a sheet thickness, and the body-text setting information includes a binding method, a sheet type, and a sheet thickness. The binding direction in the front-cover setting information is the direction in which the front cover of the printed matter is bound, the sheet type in the front-cover setting information is the type of sheet used as the front cover of the printed matter, and the sheet thickness in the front-cover setting information is the thickness of the sheet used as the front cover of the printed matter. The binding direction in the body-text setting information is the direction in which the body text of the printed matter is bound, the sheet type in the body-text setting information is the type of sheet or sheets used for the body text of the printed matter, and the sheet thickness in the body-text setting information is the thickness of the sheet or sheets used for the body text of the printed matter.

The received-order information DB 37 is a database that stores and manages received-order information to be used during the order receiving process. Each piece of received-order information includes, for example, a received-order ID, a product type, a step, a device ID, a price, a shipping cost, and a deliverable date. A product type is the type of registered product for which an order is receivable by an order receiver or the type of product for which an order is placeable by an orderer, and is, for example, information indicating the type of printed matter to be produced, such as a catalog, a calendar, a paperback book, or a magazine. A step is information indicating a step executable by a user receiving an order. A price is the cost required when an order is received and may vary depending on the grades set for the number of pages or copies or the time left until the delivery date. A shipping cost is the cost required for shipping the printed matter. A deliverable date is the date of delivery input by an order receiver.

The order information DB 38 is a database that stores and manages order information registered by a user who desires to place an order for production of printed matter. Each piece of order information includes, for example, an order ID, a specification ID, a product type, the number of copies, a price, and a delivery date. The number of copies is the number of produced sheets of printed matter per order. A delivery date is the date of delivery of printed matter desired by an orderer or is the desired number of days until delivery from when an order is placed (or received). A price is the price desired by an orderer.

For example, when an orderer or an order receiver registers a printer owned by the orderer or the order receiver, the orderer or the order receiver operates a terminal 11 set at his/her own site to input user information, device information, and specification information thereto and to transmit these pieces of input information to the printed-matter order placing-receiving server 10 according to this exemplary embodiment. In response to this, the acquiring unit 30 of the printed-matter order placing-receiving server 10 acquires these pieces of information received from the terminal 11. The storage unit 31 stores the acquired pieces of information in the user information DB 34, the device information DB 35, and the specification information DB 36 as databases according to the types of information. In this case, the user information is registered in the user information DB 34, and a device ID based on which the device owned by the user is uniquely identifiable is stored as the user information in the user information DB 34. In this case, a device ID identical to the device ID registered in the user information DB 34 is stored as a device ID in the device information DB 35. Likewise, an identical specification ID acquired by being received from the terminal 11 is stored as a specification ID in the device information DB 35 and the specification information DB 36. Accordingly, devices owned by the orderer and the order receiver and information about the specifications executable by the devices are stored in association with the user information DB 34.

Furthermore, when an orderer or an order receiver registers a device the operational status of which the orderer or the order receiver desires to check, the acquiring unit 30 acquires a device ID input by the orderer or the order receiver by receiving the device ID from the corresponding terminal 11, and stores the acquired device ID as a device ID in the user information DB 34. In this case, the device ID stored in the device information DB 35 is stored as a device ID in the user information DB 34 related to the orderer or the order receiver. Accordingly, device information that the orderer or the order receiver desires to access is stored in association with the user information DB 34 of the orderer or the order receiver.

Since each user owns one or more devices and desires to check the operational status of one or more devices, at least one piece of device information is associated with one piece of user information by using a device ID, as shown in FIG. 5. Because the printer specifications are predetermined for each printer, one piece of specification information is associated with one piece of device information by using a specification ID.

When an order receiver registers received-order information, the acquiring unit 30 acquires device information, specification information, and received-order information input by the order receiver, and the storage unit 31 stores the acquired pieces of information in the device information DB 35, the specification information DB 36, and the received-order information DB 37. In this case, the received-order ID stored in the received-order information DB 37 is stored as a received-order ID in the user information DB 34. The device ID stored in the device information DB 35 is stored as a device ID in the received-order information DB 37. The specification ID stored in the specification information DB 36 is stored as a specification ID in the device information DB 35. Accordingly, device information, device-specification-related information, and received-order information registered by the order receiver are stored in association with user information of the order receiver.

The received-order information DB 37 is not stored until registration is performed by an order receiver. Specifically, as shown in FIG. 5, zero or more received-order information DBs 37 are associated with one user information DB 34 by using a received-order ID. Furthermore, with regard to the received-order information DB 37, one or more device information DBs 35 are associated with one piece of received-order information by using a device ID, so as to register a device allocable to a product, for which an order is to be received, for each step.

In a case where an orderer registers order information, the acquiring unit 30 acquires order information and specification information input by the orderer, and the storage unit 31 stores the acquired information in the specification information DB 36 and the order information DB 38. In this case, the order ID stored in the order information DB 38 is stored as an order ID in the user information DB 34 of the orderer, and the specification ID stored in the specification information DB 36 is stored as a specification ID in the order information DB 38.

Accordingly, the order information placed by the orderer and the information related to the specifications of the printed matter are stored in association with the user information DB 34.

Because an orderer may sometimes register multiple orders, zero or more order information DBs 38 may be associated with one user information DB 34 by using an order ID, as shown in FIG. 5. Moreover, with regard to the order information DB 38, the specifications of one item of printed matter are set for one order. Thus, one specification information DB 36 is associated with one piece of order information by using a specification ID.

In FIG. 4, the deriving unit 32 uses the device information DB 35 to derive the operating rate and the schedule for each printer. In a case where an order receiver receives an order, the deriving unit 32 uses the device information DB 35 to derive the operating rate of each device before the reception of the order, the operating rate of each device after the reception of the order, and the amount of change in the operating rate. Furthermore, the deriving unit 32 uses condition information to derive compatible received-order information and compatible order information. In this exemplary embodiment, condition information contains a product type, an address, a designated amount of change, a sheet size, a sheet type, and a step. A designated amount of change refers to an amount of change in the operating rate that changes when production of certain printed matter is undertaken.

The display-information generating unit 33 generates information (referred to as “display information” hereinafter) for displaying the derived operating rate and schedule on the terminals 11 operated by the orderer and the order receiver, and transmits the display information to the terminals 11. Furthermore, the display-information generating unit 33 generates display information of the received-order information and order information compatible with the condition information, and transmits the display information to the terminals 11.

In detail, when the orderer and the order receiver check the operational status, the acquiring unit 30 uses the device ID in the user information DB 34 shown in FIG. 5 to acquire the device name, the process name, and the process date and time from the device information DB 35. The deriving unit 32 uses the acquired process date and time to derive the operational status and the operating rate for each day, and uses the acquired device name, process name, and process date and time to derive the schedule per day for each device. The display-information generating unit 33 generates information for displaying the derived operational status and schedule, and transmits the information to the terminals 11.

Furthermore, the user who desires to undertake the production of the printed matter searches for acceptable order information from the order information registered in the printed-matter order placing-receiving server 10, so as to receive an acceptable order. When the order receiver searches for acceptable order information, the deriving unit 32 searches for user information, specification information, and order information that are compatible with condition information input by the order receiver from the user information DB 34, the specification information DB 36, and the order information DB 38 registered by the orderer. The display-information generating unit 33 transmits, to the terminals 11, display information for displaying the user information, the specification information, and the order information compatible with the condition information as an order-information candidate.

For example, as condition information for printed matter producible by user's own company, the user who desires to undertake the production of the printed matter sets the type of product (product type) producible by the printing company and an executable step as search conditions, and transmits the set information to the printed-matter order placing-receiving server 10. The printed-matter order placing-receiving server 10 receives the information and uses the condition information acquired by the acquiring unit 30 of the printed-matter order placing-receiving server 10 to search for the product type and the order ID compatible with the step from the order information DB 38, and derives order information and user information associated with the order ID. The display-information generating unit 33 transmits, to the terminals 11, display information for displaying the derived user information and order information as an order-information candidate.

The user undertaking the production of the printed matter may sometimes desire to keep an increase in the operating rate, caused as a result of undertaking the production, within a certain range. Undertaking an order that involves a large amount of production may lead to saturation in the amount of production by the company or a rapid increase in the load on the operator actually managing each device. Since there may be a desire to prevent this, there may a case where orders to be undertaken are to be extracted in view of an increase in the operating rate as a condition. If an amount of change in the operating rate is designated by the order receiver (i.e., a designated amount of change) as condition information used by the user for searching for registered order information, the deriving unit 32 searches for a printer or post-processing device owned by the order receiver, so as to derive the operating rate before the reception of the order from the process date and time of the retrieved device. The deriving unit 32 searches for order information allocable to the printer, allocates the retrieved order information to the printer, and calculates the operating rate after the reception of the order. The deriving unit 32 derives an amount of change in the operating rate for each piece of order information from the operating rate before the reception of the order and the operating rate after the reception of the order. The display-information generating unit 33 uses the designated amount of change and the amount of change in the operating rate for each piece of order information to identify order information, and derives user information associated with the order information. The display-information generating unit 33 transmits, to the terminals 11, display information for displaying the derived user information and order information as an order-information candidate.

When the orderer searches for received-order information, the deriving unit 32 searches for user information, specification information, and received-order information that are compatible with the condition information input by the orderer from the user information DB 34, the specification information DB 36, and the received-order information DB 37 registered by the order receiver. The display-information generating unit 33 transmits, to the terminals 11, the user information, specification information, and received-order information compatible with the condition information as a received-order-information candidate.

In this exemplary embodiment, when a printer that the orderer and the order receiver desire to access is registered, the operating rate and the schedule of the registered device are accessed. Alternatively, for example, an authority level may be set for each of the orderer and the order receiver or for each device, so as to control users who are allowed to access the operating rate and the schedule, or control users who are allowed to access the operating rate alone or the schedule alone. A user of the printed-matter order placing-receiving system 1 according to this exemplary embodiment is not limited to an order receiver of a printing company. An orderer who desires to order printed matter may also use this system. It is also conceivable for multiple order receivers, that is, multiple printing companies, to use the system in an information-sharing fashion. Normally, it may be problematic for such printing companies to share information unlimitedly since the printing companies may possibly be competitors. For example, it is not desirable that information about the status of each device owned by another printing company as a competitor, information about the operational status of each device, information about the set price during an order receiving process, and information about acceptable printing and processing conditions be entirely disclosed to a company that may be a competitor to some extent. Likewise, if users as order receivers belong to respective companies having a certain cooperative relationship with each other, one of the companies may sometimes desire to request a part of production of printed matter undertaken by the company to the other company having the cooperative relationship therewith. Information may be disclosed to a certain extent to a user who may possibly be an orderer, so that opportunities for receiving acceptable orders for production of printed matter may be increased. Accordingly, information to be accessed by each user varies in level of accessibility depending on the relationship with the user, and it is desirable that information to be accessed be predetermined in accordance with each level.

With regard to authority levels for accessibility of information, it is more desirable that the level of authority for accessibility be set for each user or for each device and each user, and that information according to each authority level be provided to each user.

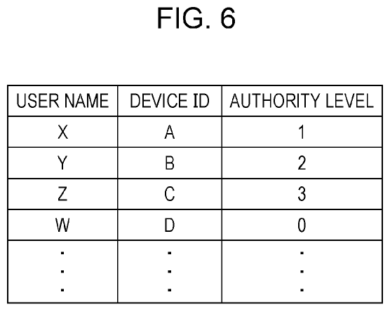

In detail, the operating rate and the schedule of each accessible device are set in accordance with the level of authority (referred to as “authority level” hereinafter) for accessibility for each user. For example, as shown in FIG. 6, the user information DB 34 has stored therein user names, device IDs, and authority levels. FIG. 6 illustrates an example of authority levels in the printed-matter order placing-receiving server 10 according to this exemplary embodiment.

For example, levels “0”, “1”, “2”, and “3” are set as the authority levels. When the authority level is “0”, the operating rate and the schedule are not accessible. When the authority level is “1”, the operating rate alone is accessible. When the authority level is “2”, the schedule alone is accessible. When the authority level is “3”, the operating rate and the schedule are accessible.

For example, in a case where the authority level “1” is set to a device with a device ID “A” for a user with a user name “X”, the user name “X” is allowed to access the operating rate of the device corresponding to the device ID “A”. In a case where the authority level “2” is set to a device with a device ID “B” for a user with a user name “Y”, the user name “Y” is allowed to access the schedule of the device corresponding to the device ID “B”. In a case where the authority level “3” is set to a device with a device ID “C” for a user with a user name “Z”, the user name “Z” is allowed to access the operating rate and the schedule of the device corresponding to the device ID “C”. In a case where the authority level “0” is set to a device with a device ID “D” for a user with a user name “W”, the user name “W” is not allowed to access the operating rate and the schedule of the device corresponding to the device ID “D”.

In the user information DB 34 according to this exemplary embodiment, one device ID and one authority level are set for each user name. Alternatively, in a case where a user owns multiple printers or multiple post-processing devices, multiple device IDs may be set for each user name or user ID, and an authority level may be set for each device ID. Each authority level according to this exemplary embodiment is an example of an authority level.

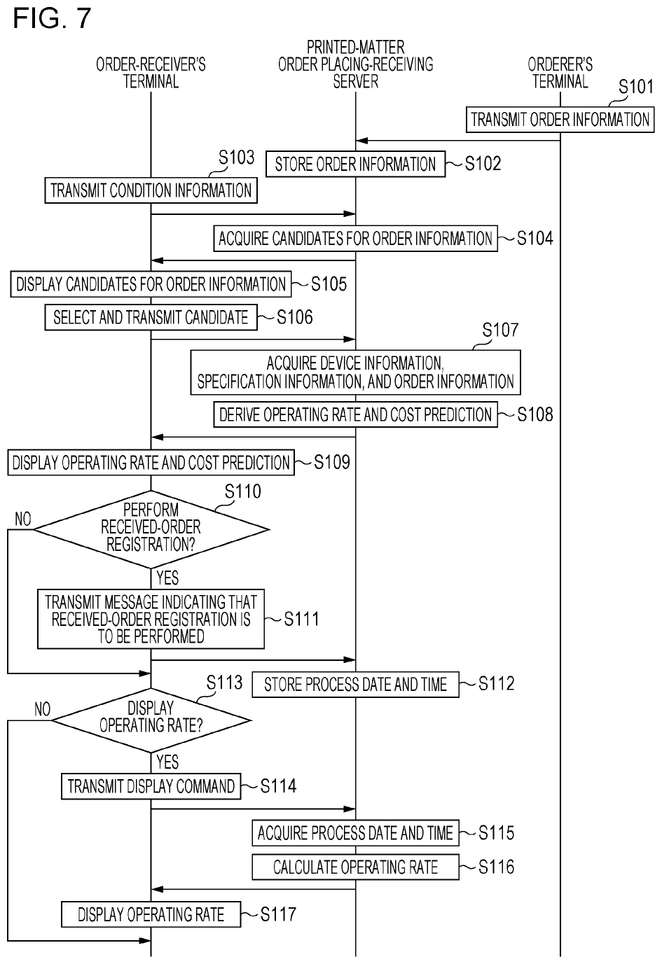

Before describing the operation of the printed-matter order placing-receiving server 10, a method performed by the printed-matter order placing-receiving server 10 according to this exemplary embodiment for deriving and displaying the operating rate will be described with reference to FIGS. 7 to 13. In the following description, a terminal 11 operated by an orderer will be referred to as “orderer's terminal”, whereas a terminal 11 operated by an order receiver will be referred to as “order-receiver's terminal”.

A process involving searching for order information to be received by a user and receiving the order by using the printed-matter order placing-receiving system 1 will be described. FIG. 7 is a sequence diagram illustrating an example of the flow of the order receiving process in the printed-matter order placing-receiving system 1 according to this exemplary embodiment.

For example, as shown in FIG. 7, the orderer's terminal transmits input order information to the printed-matter order placing-receiving server 10 in step S101.

In step S102, the printed-matter order placing-receiving server 10 stores the acquired order information in the storage unit 24.

If an order receiver searches for the order information to be received, the order-receiver's terminal transmits input condition information to the printed-matter order placing-receiving server 10 in step S103.

In step S104, the printed-matter order placing-receiving server 10 acquires candidates for the order information compatible with the acquired condition information from the storage unit 24, and transmits the candidates for the order information to the order-receiver's terminal.

The order-receiver's terminal displays the received candidates for the order-information in step S105 and transmits the selected order information to the printed-matter order placing-receiving server 10 in step S106.

In step S107, the printed-matter order placing-receiving server 10 acquires, from the storage unit 24, device information related to the order receiver, the selected order information, specification information related to the selected order information.

The printed-matter order placing-receiving server 10 derives the operating rate before the reception of the order from the process date and time in the acquired device information. The printed-matter order placing-receiving server 10 derives the operating rate after the reception of the order from the acquired order information, specification information, and device information. The printed-matter order placing-receiving server 10 derives a cost prediction in the order information from the acquired order information and specification information. The printed-matter order placing-receiving server 10 transmits the derived operating rate and cost prediction to the order-receiver's terminal in step S108.

In step S109, the order-receiver's terminal displays the received operating rate and cost prediction. Moreover, in step S110, the order-receiver's terminal determines whether or not received-order registration is to be performed. If received-order registration is to be performed, the order-receiver's terminal transmits, to the printed-matter order placing-receiving server 10 in step S111, a message indicating that received-order registration is to be performed. In this case, the order-receiver's terminal transmits the process date and time for performing the process for the printed matter according to the order information set by the order receiver, together with the message indicating that received-order registration is to be performed.

If the printed-matter order placing-receiving server 10 receives the message indicating that received-order registration is to be performed, the printed-matter order placing-receiving server 10 sets the process date and time, set by the order receiver, for performing the process as the process date and time in the device information, and stores the process date and time in the storage unit 24 in step S112.

In step S113, the order-receiver's terminal determines whether or not the operating rate is to be displayed. If the operating rate is to be displayed, the order-receiver's terminal transmits a command for displaying the operating rate to the printed-matter order placing-receiving server 10 in step S114.

When the printed-matter order placing-receiving server 10 receives the command for displaying the operating rate, the printed-matter order placing-receiving server 10 acquires the process date and time stored in the device information DB 35 from the storage unit 24 in step S115, derives the operating rate, and transmits the operating rate to the order-receiver's terminal in step S116.

The order-receiver's terminal displays the received operating rate in step S117.

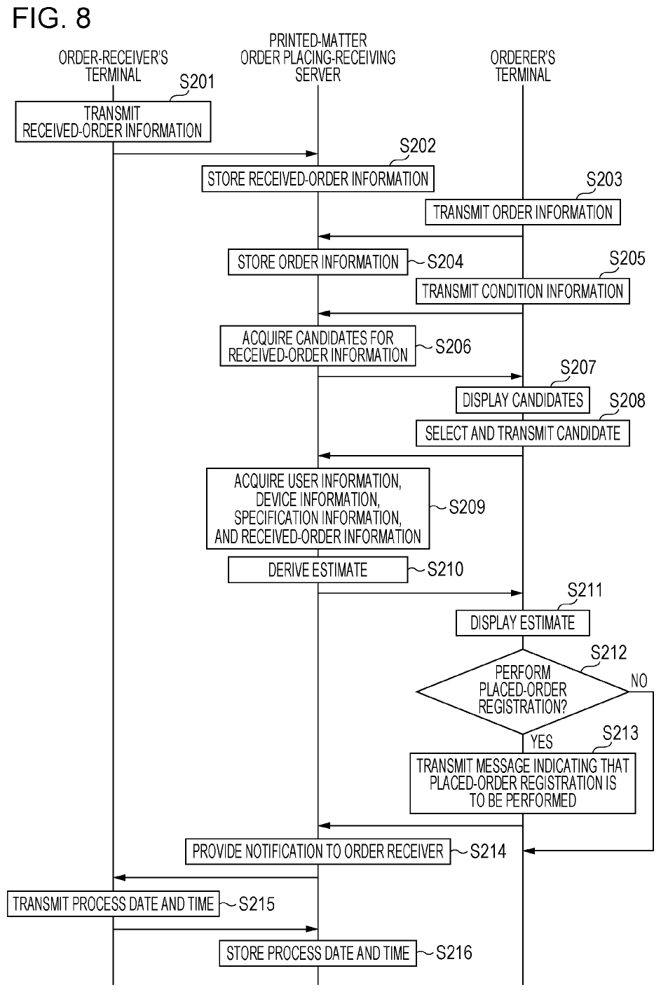

Next, a process in which an orderer designates an order receiver and places an order by using the printed-matter order placing-receiving system 1 will be described with reference to FIG. 8. FIG. 8 is a sequence diagram illustrating an example of the flow of the ordering process in the printed-matter order placing-receiving system 1 according to this exemplary embodiment.

For example, as shown in FIG. 8, the order-receiver's terminal transmits received-order information to the printed-matter order placing-receiving server 10 in step S201.

In step S202, the printed-matter order placing-receiving server 10 stores the acquired received-order information in the storage unit 24.

In step S203, the orderer's terminal transmits order information input by the orderer to the printed-matter order placing-receiving server 10.

In step S204, the printed-matter order placing-receiving server 10 stores the acquired order information in the storage unit 24.

If the received-order information is to be searched for, the orderer's terminal transmits input condition information to the printed-matter order placing-receiving server 10 in step S205.

In step S206, the printed-matter order placing-receiving server 10 acquires candidates for the received-order information compatible with the acquired condition information from the storage unit 24, and transmits the candidates for the received-order information to the orderer's terminal.

The orderer's terminal displays the received candidates for the received-order information in step S207 and transmits the selected received-order information to the printed-matter order placing-receiving server 10 in step S208.

The printed-matter order placing-receiving server 10 acquires, from the storage unit 24, the selected received-order information as well as user information, device information, and specification information related to the received-order information in step S209. In step S210, the printed-matter order placing-receiving server 10 derives an estimate of, for example, the cost and processing time required when a device executes the process according to the order information, and transmits the estimate to the orderer's terminal.

In step S211, the orderer's terminal displays the received estimate. In step S212, the orderer's terminal determines whether or not placed-order registration is to be performed. If placed-order registration is to be performed, the orderer's terminal transmits, to the printed-matter order placing-receiving server 10 in step S213, a message indicating that placed-order registration is to be performed. In this case, the orderer's terminal transmits the order information to be placed together with the message indicating that placed-order registration is to be performed.

If the printed-matter order placing-receiving server 10 receives the message indicating that placed-order registration is to be performed, the printed-matter order placing-receiving server 10 notifies the order receiver related to the received-order information selected by the orderer that an order has been placed in step S214. In step S215, the printed-matter order placing-receiving server 10 transmits a notification indicating that an order has been placed together with the placed-order information.

If the order-receiver's terminal receives the notification indicating that an order has been placed, the order-receiver's terminal transmits, to the printed-matter order placing-receiving server 10, the device ID of the device that processes the order according to the received order information as well as the process date and time.

In step S216, the printed-matter order placing-receiving server 10 sets and stores the device ID, the process date and time, and the process according to the order information in the device information DB 35 stored in the storage unit 24.

This exemplary embodiment relates to a case where an order receiver is searched for after order information is registered, and an order is subsequently placed.

Alternatively, the order information may be registered when an order is placed, or the order information may be registered at any time so long as it is registered before the order information is placed by an orderer.

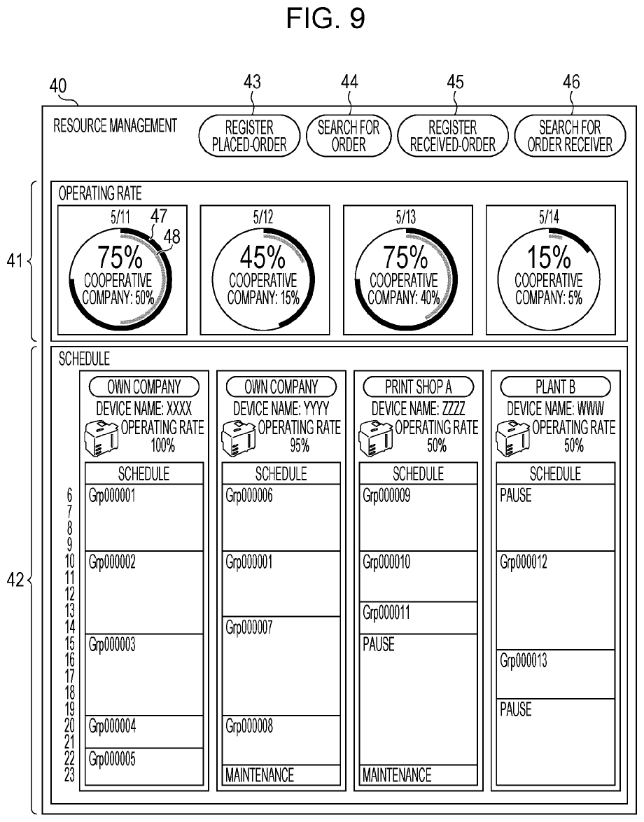

Next, a screen that displays an operational status, a screen used for registering order information, a screen used for searching for order information, a screen used for registering received-order information, and a screen used for searching for received-order information will be described with reference to FIGS. 9 to 13.

First, the operational-status display screen according to this exemplary embodiment will be described with reference to FIG. 9. FIG. 9 schematically illustrates an example of the operational-status display screen of the printed-matter order placing-receiving server 10 according to this exemplary embodiment.

For example, as shown in FIG. 9, a resource management screen 40 includes an operating-rate display region 41 that displays operating rates, a schedule display region 42 that displays schedules, a register placed-order button 43, a search-for-order button 44, a register received-order button 45, and a search-for-order-receiver button 46.

The operating-rate display region 41 displays an operating rate per day of a device owned by the own company and registered by an orderer and an order receiver and an operating rate per day of a device owned by, for example, a cooperative company and registered by the orderer and the order receiver. In the following description, the operating rates per day of all devices registered by the orderer and the order receiver will be referred to as “overall operating rate”, and the operating rate of the device owned by, for example, the cooperative company will be referred to as “operating rate of cooperative company”.

For example, referring to the operational status on “5/11” displayed in the operating-rate display region 41, the operating-rate display region 41 includes an outer ring 47 visually displaying the overall operating rate and an inner ring 48 visually displaying the operating rate of the cooperative company. With regard to the overall operating rate and the operating rate of the cooperative company, the outer ring 47 and the inner ring 48 are displayed such that they become closer to a circular shape as the operating rates increase. When the operating rates become 100 percent, the outer ring 47 and the inner ring 48 are displayed in a circular shape. The overall operating rate and the operating rate of the cooperative company are respectively displayed with two levels of text strings located further within the outer ring 47 and the inner ring 48, such that the overall operating rate is displayed at the upper level and the operating rate of the cooperative company is displayed at the lower level.

The schedule display region 42 displays schedules for designated dates on which the individual devices execute processes. For example, if the operating rate on “5/11” is selected in the operating-rate display region 41, the schedule display region 42 displays the schedule for “5/11” with respect to a device registered by the orderer and the order receiver. The schedule display region 42 displays the operating rates of printers, including printers of the own company registered by the orderer and the order receiver and printers of cooperative companies, and process names of processes on an hour-by-hour basis.

Specifically, referring to the operating-rate display region 41 and the schedule display region 42 of the resource management screen 40, an order is placed and received while the operating rate and the schedule of the own company indicating the orderer and the order receiver as well as the operating rate and the schedule of each cooperative company registered by the orderer and the order receiver are confirmed.

The orderer and the order receiver press the register placed-order button 43, the search-for-order button 44, the register received-order button 45, and the search-for-order-receiver button 46 displayed on the resource management screen 40, so as to place and receive an order.

The resource management screen 40 according to this exemplary embodiment displays the operating rate and the schedule of each device per day, but may alternatively display, for example, the operating rate and the schedule of each device per step. In this case, the steps are divided processes for producing printed matter and include a preprinting step, a printing step, a processing step, a bookbinding step, and a shipping step.

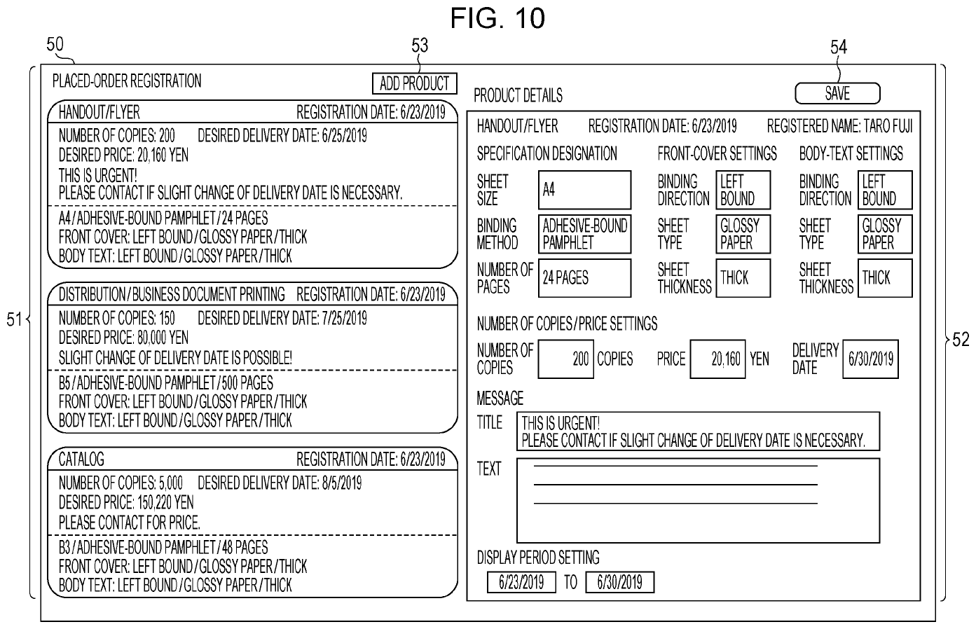

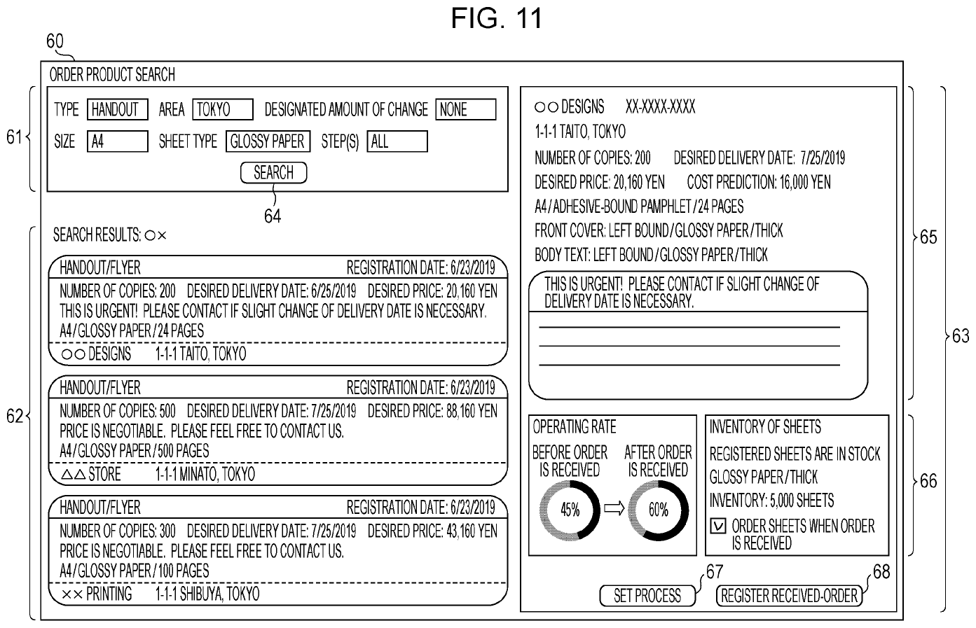

Next, a method of how an order receiver searches for an order and receives the order in accordance with this exemplary embodiment will be described with reference to FIGS. 10 and 11. First, a method of how an orderer registers an order will be described with reference to FIG. 10. FIG. 10 schematically illustrates an example of a screen used for registering order information in the printed-matter order placing-receiving server 10 according to this exemplary embodiment.

For example, as shown in FIG. 10, a placed-order registration screen 50 includes a product display region 51 and a product details display region 52. With regard to the placed-order registration screen 50, the resource management screen 40 transitions to the placed-order registration screen 50 when the register placed-order button 43 in the resource management screen 40 is pressed.

The product display region 51 displays a list of products for which an orderer places an order. For example, the orderer adds a product by pressing an add product button 53, whereby the added product is displayed in the product display region 51. Furthermore, when the orderer presses and selects a product displayed in the product display region 51, the product is displayed in the product details display region 52.

The product details display region 52 displays detailed information about the product selected in the product display region 51 and accepts an input of detailed information about the product from the orderer. For example, the product details display region 52 accepts order information containing a product type of printed matter, the number of copies, a price, a delivery date, and a display period setting, and accepts specification information containing specification designation information, front-cover setting information, and body-text setting information. Specification designation information contains a sheet size of printed matter, a binding method, and the number of pages. Front-cover setting information contains a binding direction for a front cover of printed matter, a sheet type, and a sheet thickness. Body-text setting information contains a binding direction for body text of printed matter, a sheet type, and a sheet thickness.

When a save button 54 included in the product details display region 52 is pressed, the printed-matter order placing-receiving server 10 stores the product type of the printed matter, the number of copies, the price, the delivery date, the display period setting, and the specification information of the printed matter as order information and specification information into the storage unit 24.

Specifically, when the orderer orders a product without designating an order receiver, the orderer places the order from the placed-order registration screen 50.

Next, a method for searching for order information in accordance with this exemplary embodiment will be described with reference to FIG. 11. FIG. 11 schematically illustrates an example of a screen used for searching for order information in the printed-matter order placing-receiving server 10 according to this exemplary embodiment.

For example, as shown in FIG. 11, an order search screen 60 includes a condition-information input region 61, a search-result display region 62, and an order-information details display region 63. With regard to the order search screen 60, the resource management screen 40 transitions to the order search screen 60 when the search-for-order button 44 in the resource management screen 40 is pressed.

The condition-information input region 61 accepts an input of condition information, such as a product type, an area where an orderer is located, a designated amount of change, a sheet size, a sheet type, and a target step or steps as condition information. When a search button 64 included in the condition-information input region 61 is pressed after the condition information is input by an order receiver, user information, specification information, and order information are searched for, and the search-result display region 62 is displayed.

The search-result display region 62 displays a product type, the number of copies, a desired delivery date, a desired price, a message, a user name, and an address as each candidate for the order information. When a candidate for the order information is selected by an orderer, the order-information details display region 63 is displayed.

The order-information details display region 63 includes an order-information display region 65, a received-order-information display region 66, a set process button 67, and a register received-order button 68. The order-information display region 65 displays a user name registered by the orderer, a telephone number, an address, the number of copies, a desired delivery date, a desired price, a cost prediction, specification information of a product to be printed, and a message. When the order receiver receives the selected order information, the received-order-information display region 66 displays the operating rate of a printer related to the order receiver before and after the reception of the order information. Furthermore, if the inventory of sheets is registered, the order-information details display region 63 displays the sheet type corresponding to the order information and the number of sheets in stock, and accepts whether or not to make preparations for the corresponding sheets.

When the order receiver presses the set process button 67 included in the order-information details display region 63, the printed-matter order placing-receiving server 10 accepts an input of a process date and time for executing a process according to the order information.

When the order receiver presses the register received-order button 68 included in the order-information details display region 63, the printed-matter order placing-receiving server 10 stores the process according to the selected order information and the input process date and time as device information in the storage unit 24. The printed-matter order placing-receiving server 10 then notifies the orderer that the order has been received.

Specifically, in a case where the order receiver is to search for order information and receive an order, the order receiver searches for the order information from the order search screen 60, designates the order information, and receives the order.

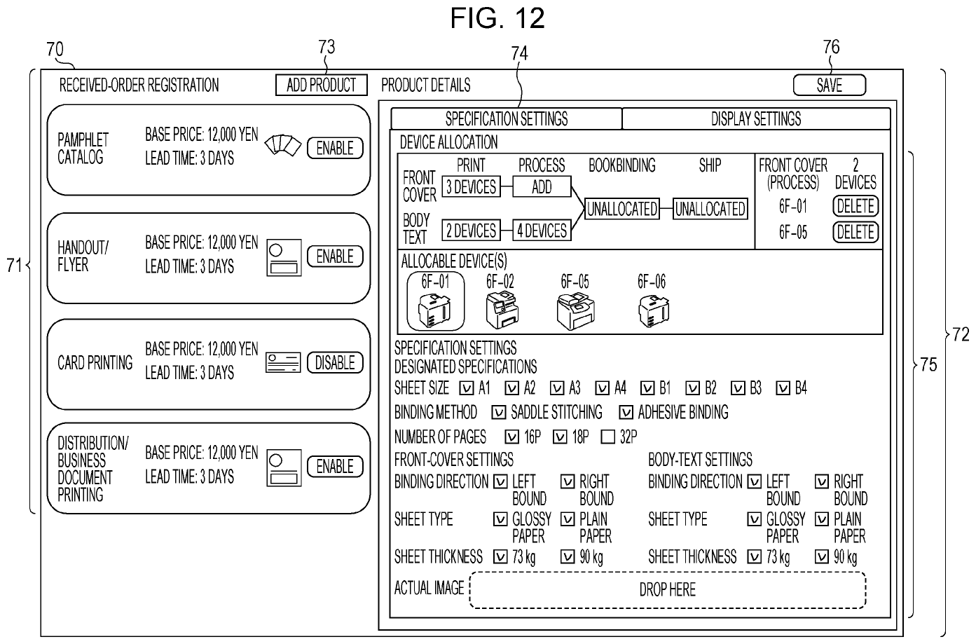

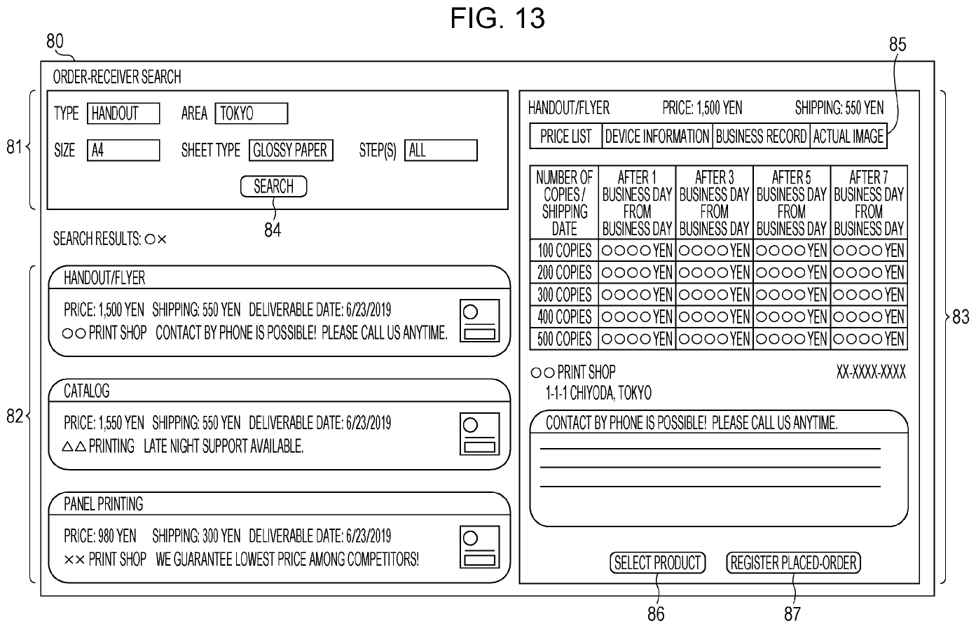

Next, a method of how an orderer searches for an order receiver and places an order in accordance with this exemplary embodiment will be described with reference to FIGS. 12 and 13. First, a case where an order receiver registers received-order information will be described with reference to FIG. 12. FIG. 12 schematically illustrates an example of a screen used for registering received-order information in the printed-matter order placing-receiving server 10 according to this exemplary embodiment.

For example, as shown in FIG. 12, a received-order registration screen 70 includes an orderable-product display region 71 and a product details display region 72. With regard to the received-order registration screen 70, the resource management screen 40 transitions to the received-order registration screen 70 when the register received-order button 45 in the resource management screen 40 is pressed.

The orderable-product display region 71 displays a list of products for which an order is receivable by an order receiver. For example, when a product is added by pressing an add product button 73, the added product is displayed in the orderable-product display region 71. Furthermore, when a product displayed in the orderable-product display region 71 is pressed and selected, the product details display region 72 is displayed.

The product details display region 72 accepts an input of specification information, such as a printer for each step that is capable of handling the selected product, specification settings for each printer, a base price if the order for the product is received, a lead time, and a cost corresponding to the number of copies and the lead time. For example, when a “set specifications” option of a display switch tab 74 included in the product details display region 72 is pressed, the received-order registration screen 70 displays a device allocation setting region 75 in the product details display region 72.

The device allocation setting region 75 displays printers for individual steps that are capable of handling the selected product, as well as specifications capable of handling the selected product for each step and for each printer.

For example, in a case where a “pamphlet catalog” option is selected in the orderable-product display region 71, devices for individual steps involving processing the front cover and the body text of the product are set in the device allocation setting region 75 of the product details display region 72. For example, at the upper level of the device allocation setting region 75, printers “6F-01” and “6F-05” are allocated to the step for processing the front cover. At the lower level of the device allocation setting region 75, specification settings corresponding to the selected printer “6F-01” are input. The specification settings include specification designation information, such as a sheet size, a binding method, and the number of pages, front-cover setting information, such as a binding direction, a sheet type, and a sheet thickness, body-text setting information, such as a binding direction, a sheet type, and a sheet thickness, and an image as an actual image. When a “display settings” option of the display switch tab 74 is pressed, the received-order registration screen 70 displays a region used for setting the shipping cost, the number of copies, the lead time, and the cost corresponding to the number of copies and the lead time.

When a save button 76 included in the product details display region 72 is pressed, the printed-matter order placing-receiving server 10 stores the product type, the steps, the specification settings for each printer, the lead time, and the cost corresponding to the number of copies and the lead time as device information, received-order information, and specification information in the storage unit 24.

Specifically, when an order receiver receives an order, the order receiver registers the received-order information, the device information, and the specification information from the received-order registration screen 70.

Next, a screen used for searching for an order receiver in accordance with this exemplary embodiment will be described with reference to FIG. 13. FIG. 13 schematically illustrates an example of a screen used for searching for received-order information in the printed-matter order placing-receiving server 10 according to this exemplary embodiment.

For example, as shown in FIG. 13, an order-receiver search screen 80 includes a condition-information input region 81, a search-result display region 82, and an order-receiver details display region 83. With regard to the order-receiver search screen 80, the resource management screen 40 transitions to the order-receiver search screen 80 when the search-for-order-receiver button 46 in the resource management screen 40 is pressed.

The condition-information input region 81 accepts an input of condition information, such as a product type, an area where an order receiver is located, a sheet size, a sheet type, and a target step or steps. When a search button 84 included in the condition-information input region 81 is pressed after the condition information is input by an orderer, user information, specification information, and received-order information are searched for, and the search-result display region 82 is displayed. The search-result display region 82 displays a product type, a price, a shipping cost, a deliverable date, a user name, and a message as each order-receiver candidate compatible with the condition information.

When the orderer selects an order-receiver candidate in the search-result display region 82, the order-receiver details display region 83 is displayed.

The order-receiver details display region 83 includes a display switch tab 85, a select product button 86, and a register placed-order button 87. The order-receiver details display region 83 displays a product type, a price, a shipping cost, a cost corresponding to the number of copies and a lead time, a user name, a telephone number, an address, and a message registered by the order receiver. When the display switch tab 85 is pressed, the order-receiver details display region 83 displays a price list, device information owned by the order receiver, a business record, and an actual image in a switching fashion. When the select product button 86 is pressed, the order-receiver details display region 83 displays a list of products registered on the placed-order registration screen 50 by the orderer so as to accept an input of a product to be ordered.

When the register placed-order button 87 is pressed by the orderer, the printed-matter order placing-receiving server 10 notifies the selected order receiver of the order information related to the input product.

Specifically, when an order is to be placed by searching for an order receiver, the orderer designates an order receiver and places an order on the order-receiver search screen 80. The designated order receiver confirms the order information, sets the process date and time for a printer, and executes a process according to the order information.

As an alternative to this exemplary embodiment in which an order is placed to an order receiver after a preliminarily registered product is selected, an input of new order information may be accepted when the register placed-order button 87 is pressed.

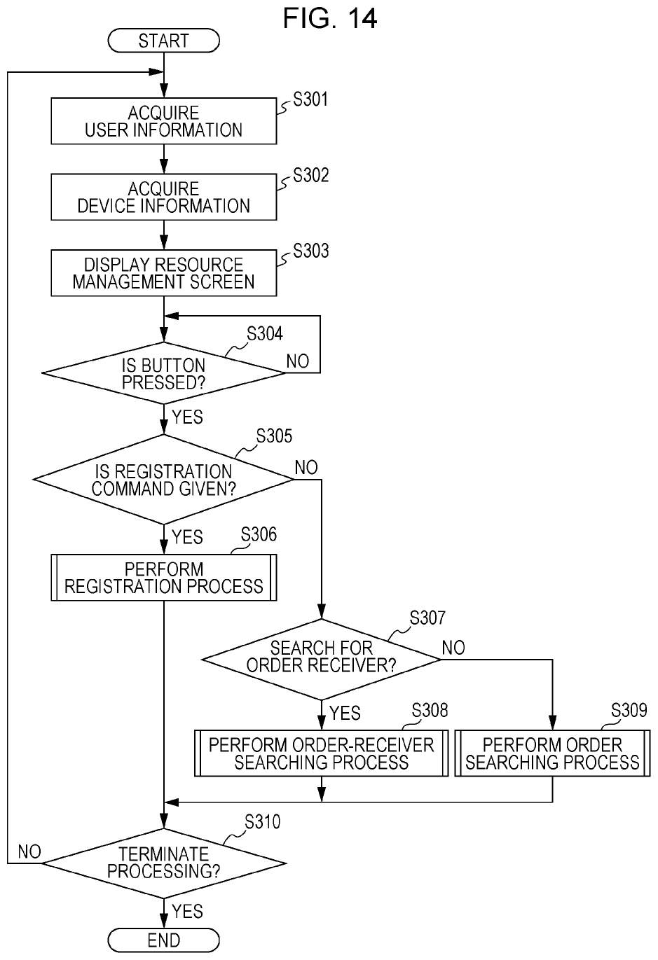

Next, the operation of a printed-matter order placing-receiving program according to an exemplary embodiment will be described as a specific exemplary embodiment of an information processing program with reference to FIGS. 14 to 17. FIG. 14 is a flowchart illustrating an example of information processing according to this exemplary embodiment. The CPU 21 reads the printed-matter order placing-receiving program from the ROM 22 or the storage unit 24 and executes the program, whereby information processing shown in FIG. 14 is executed. With regard to the information processing shown in FIG. 14, the printed-matter order placing-receiving program is executed when, for example, a user inputs a command for executing the program.

In step S301, the CPU 21 acquires user information of an orderer and an order receiver from the storage unit 24.

In step S302, the CPU 21 acquires device information of the orderer and the order receiver from the storage unit 24.

In step S303, the CPU 21 displays the aforementioned resource management screen 40 in FIG. 9.

In step S304, the CPU 21 determines whether or not a button is pressed. If a button is pressed (YES in step S304), the CPU 21 proceeds to step S305. If a button is not pressed (NO in step S304), the CPU 21 waits until a button is pressed.

In step S305, the CPU 21 determines whether or not a registration command is given as a result of the pressing of the button. If a registration command is given (YES in step S305), the CPU 21 proceeds to step S306. If a registration command is not given (i.e., if a search command is given) (NO in step S305), the CPU 21 proceeds to step S307. A registration command is given when either one of the register placed-order button 43 and the register received-order button 45 is pressed in FIG. 9.

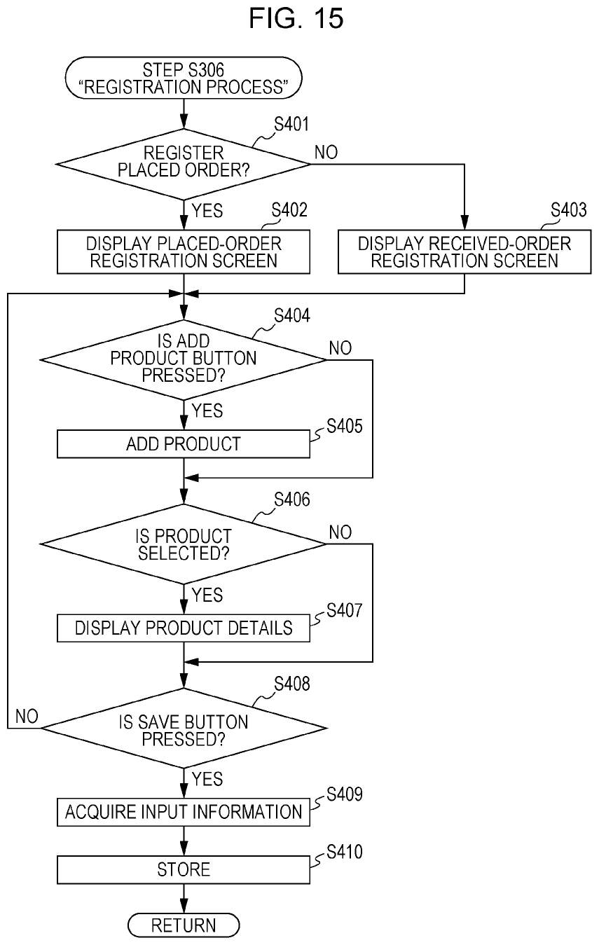

In step S306, the CPU 21 performs a registration process. The flow of the registration process will be described in detail later with reference to FIG. 15.

In step S307, the CPU 21 determines whether or not an order-receiver search command is given. If an order-receiver search command is given (YES in step S307), the CPU 21 proceeds to step S308. If an order-receiver search command is not given (i.e., if an order-information search command is given) (NO in step S307), the CPU 21 proceeds to step S309. An order-receiver search command is given when the search-for-order-receiver button 46 is pressed in FIG. 9. An order-information search command is given when the search-for-order button 44 is pressed in FIG. 9.

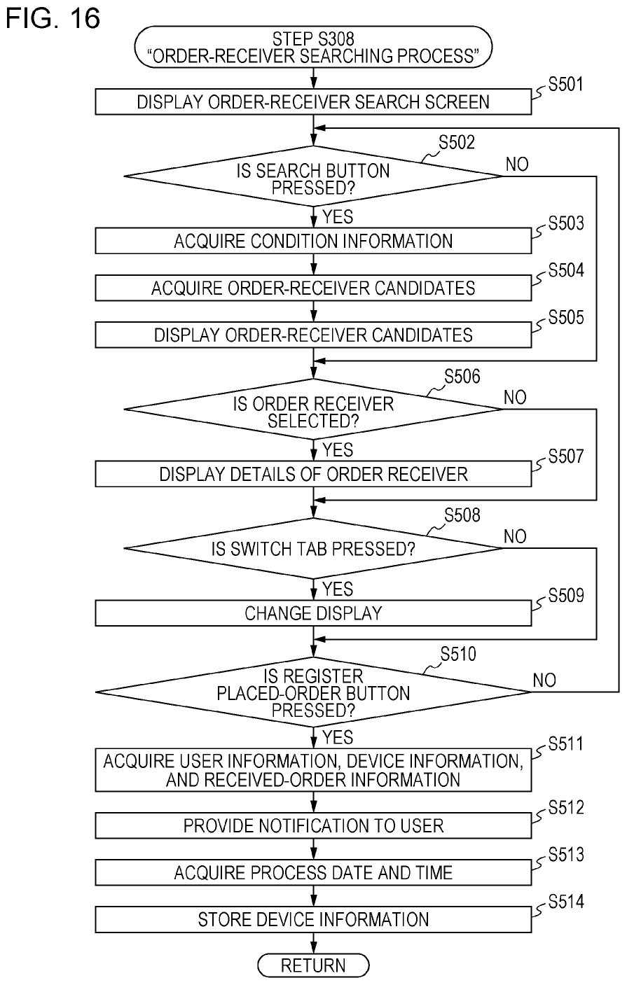

In step S308, the CPU 21 performs an order-receiver searching process. The flow of the order-receiver searching process will be described in detail later with reference to FIG. 16.

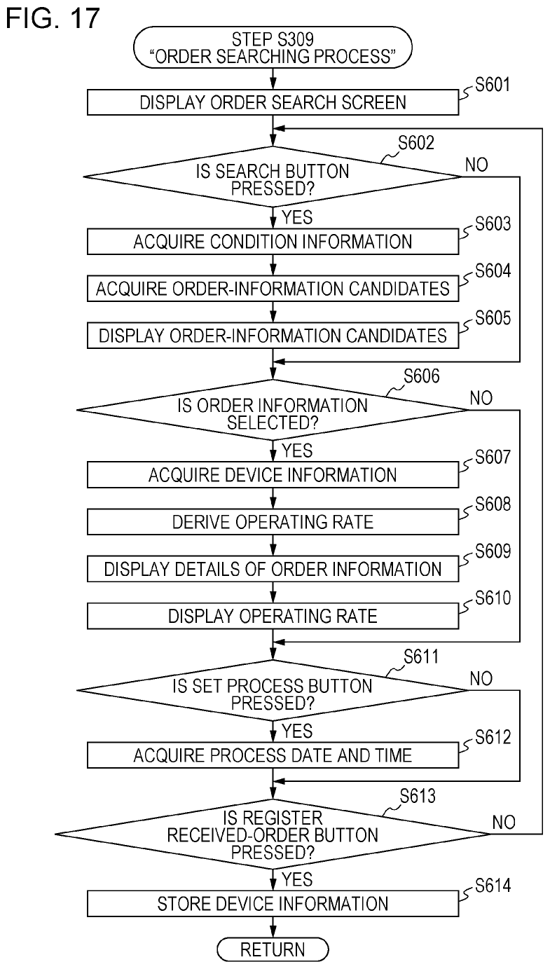

In step S309, the CPU 21 performs an order-information searching process. The flow of the order-information searching process will be described in detail later with reference to FIG. 17.

In step S310, the CPU 21 determines whether or not to terminate the information processing. If the information processing is to be terminated (YES in step S310), the CPU 21 terminates the information processing. If the information processing is not to be terminated (NO in step S310), the CPU 21 proceeds to step S301.

Next, the registration process will be described with reference to FIG. 15. FIG. 15 is a flowchart illustrating an example of the registration process according to this exemplary embodiment. The CPU 21 reads a registration process program from the ROM 22 or the storage unit 24 and executes the program, whereby the registration process shown in FIG. 15 is executed. With regard to the registration process shown in FIG. 15, for example, the registration process is executed when the orderer or the order receiver presses the register placed-order button 43 or the register received-order button 45 in FIG. 9 to input a command for executing the registration process.

In step S401, the CPU 21 determines whether or not the command input from the orderer or the order receiver is a command for registering a placed order. If the command is for registering a placed order (YES in step S401), the CPU 21 proceeds to step S402. If the command is not for registering a placed order (i.e., if the command is for registering a received order) (NO in step S401), the CPU 21 proceeds to step S403. In this case, the command for registering a placed order is given when the register placed-order button 43 is pressed in FIG. 9, and the command for registering a received order is given when the register received-order button 45 is pressed in FIG. 9.

In step S402, the CPU 21 displays the aforementioned placed-order registration screen 50 in FIG. 10.

In step S403, the CPU 21 displays the aforementioned received-order registration screen 70 in FIG. 12.

In step S404, the CPU 21 determines whether or not an add product button is pressed. If the add product button is pressed (YES in step S404), the CPU 21 proceeds to step S405. If the add product button is not pressed (NO in step S404), the CPU 21 proceeds to step S406. The add product button is either one of the add product button 53 in the placed-order registration screen 50 in FIG. 10 and the add product button 73 in the received-order registration screen 70 in FIG. 12.

In step S405, the CPU 21 adds a product and displays the added product.

In step S406, the CPU 21 determines whether or not a product is selected. If a product is selected (YES in step S406), the CPU 21 proceeds to step S407. If a product is not selected (NO in step S406), the CPU 21 proceeds to step S408. The product is either one of a product displayed in the product display region 51 in the placed-order registration screen 50 in FIG. 10 and a product displayed in the orderable-product display region 71 in the received-order registration screen 70 in FIG. 12.

In step S407, the CPU 21 displays the details of the selected product.

In step S408, the CPU 21 determines whether or not a save button is pressed. If a save button is pressed (YES in step S408), the CPU 21 proceeds to step S409. If a save button is not pressed (NO in step S408), the CPU 21 proceeds to step S404. A save button is either one of the save button 54 in the placed-order registration screen 50 in FIG. 10 and the save button 76 in the received-order registration screen 70 in FIG. 12.

In step S409, the CPU 21 acquires input information input by the orderer and the order receiver. The input information corresponds to order information and specification information in a case where the placed-order registration screen 50 in FIG. 10 is displayed, and corresponds to received-order information, device information, and specification information in a case where the received-order registration screen 70 in FIG. 12 is displayed.

In step S410, the CPU 21 stores the input information. Next, the order-receiver searching process will be described with reference to FIG. 16. FIG. 16 is a flowchart illustrating an example of the order-receiver searching process according to this exemplary embodiment. The CPU 21 reads an order-receiver searching process program from the ROM 22 or the storage unit 24 and executes the program, whereby the order-receiver searching process shown in FIG. 16 is executed. With regard to the order-receiver searching process shown in FIG. 16, for example, the order-receiver searching process is executed when the orderer presses the search-for-order-receiver button 46 to input a command for executing the order-receiver searching process.

In step S501, the CPU 21 displays the aforementioned order-receiver search screen 80 in FIG. 13.

In step S502, the CPU 21 determines whether or not a search button is pressed. If the search button is pressed (YES in step S502), the CPU 21 proceeds to step S503. If the search button is not pressed (NO in step S502), the CPU 21 proceeds to step S506.

In step S503, the CPU 21 acquires input condition information. In this case, the condition information contains a product type, an area where an order receiver is located, a sheet size, a sheet type, and a target step of steps input to the condition-information input region 61 in the order-receiver search screen 80 in FIG. 13.

In step S504, the CPU 21 searches for received-order information, user information, device information, and specification information and acquires order-receiver candidates compatible with the condition information.

In step S505, the CPU 21 displays the order-receiver candidates compatible with the condition information.

In step S506, the CPU 21 determines whether or not an order receiver is selected. If an order receiver is selected (YES in step S506), the CPU 21 proceeds to step S507. If an order receiver is not selected (NO in step S506), the CPU 21 proceeds to step S508.

In step S507, the CPU 21 displays the details of the selected order receiver. The order-receiver details display region 83 in the order-receiver search screen 80 in FIG. 13 is displayed as the details of the order receiver.

In step S508, the CPU 21 determines whether or not a display switch tab is pressed. If the display switch tab is pressed (YES in step S508), the CPU 21 proceeds to step S509. If the display switch tab is not pressed (NO in step S508), the CPU 21 proceeds to step S510. In this case, the display switch tab is the display switch tab 85 in the order-receiver search screen 80 in FIG. 13.

In step S509, the CPU 21 changes the display of the details of the order receiver.

In step S510, the CPU 21 determines whether or not a register placed-order button is pressed. If the register placed-order button is pressed (YES in step S510), the CPU 21 proceeds to step S511. If the register placed-order button is not pressed (NO in step S510), the CPU 21 proceeds to step S502. In this case, the register placed-order button is the register placed-order button 87 in the order-receiver search screen 80 in FIG. 13.

In step S511, the CPU 21 acquires the selected received-order information, the user information related to the selected received-order information, and the device information related to the received-order information.

In step S512, the CPU 21 uses the user information to notify the order receiver that an order has been placed.

In step S513, the CPU 21 acquires a process date and time for executing a process according to the order information.

In step S514, the CPU 21 sets the acquired process date and time in the device information, and stores the device information.

Next, the order searching process will be described with reference to FIG. 17. FIG. 17 is a flowchart illustrating an example of the order searching process according to this exemplary embodiment. The CPU 21 reads an order searching process program from the ROM 22 or the storage unit 24 and executes the program, whereby the order searching process shown in FIG. 17 is executed. With regard to the order searching process shown in FIG. 17, for example, the order searching process is executed when a user inputs a command for executing the order searching process.

In step S601, the CPU 21 displays the aforementioned order search screen 60 in FIG. 11.

In step S602, the CPU 21 determines whether or not a search button is pressed. If the search button is pressed (YES in step S602), the CPU 21 proceeds to step S603. If the search button is not pressed (NO in step S602), the CPU 21 proceeds to step S606. In this case, the search button is the search button 64 in the order search screen 60 in FIG. 11.

In step S603, the CPU 21 acquires input condition information. In this case, the condition information contains a product type, an area where an order receiver is located, a designated amount of change, a sheet size, a sheet type, and a target step of steps input to the condition-information input region 61 in the order search screen 60 in FIG. 11.

In step S604, the CPU 21 searches for order-information candidates compatible with the condition information, and acquires a search result.

In step S605, the CPU 21 displays the order-information candidates compatible with the condition information. The order-information candidates are displayed in the search-result display region 62 in the order search screen 60 in FIG. 11.

In step S606, the CPU 21 determines whether or not order information is selected. If order information is selected (YES in step S606), the CPU 21 proceeds to step S607. If order information is not selected (NO in step S606), the CPU 21 proceeds to step S611.

In step S607, the CPU 21 acquires device information of the order receiver.

In step S608, the CPU 21 uses the acquired device information to derive the operating rate.

In step S609, the CPU 21 displays the details of the selected order information. The details of the order information are displayed in the order-information display region 65 in the order search screen 60 in FIG. 11.

In step S610, the CPU 21 displays the derived operating rate. The operating rate is displayed in the received-order-information display region 66 in the order search screen 60 in FIG. 11.

In step S611, the CPU 21 determines whether or not a set process button is pressed. If the set process button is pressed (YES in step S611), the CPU 21 proceeds to step S612. If the set process button is not pressed (NO in step S611), the CPU 21 proceeds to step S613. In this case, the set process button is the set process button 67 in the order search screen 60 in FIG. 11.

In step S612, the CPU 21 acquires a process date and time input by the order receiver.

In step S613, the CPU 21 determines whether or not a register received-order button is pressed. If the received-order register button is pressed (YES in step S613), the CPU 21 proceeds to step S614. If the received-order register button is not pressed (NO in step S613), the CPU 21 proceeds to step S602. In this case, the received-order register button is the register received-order button 68 in the order search screen 60 in FIG. 11.

In step S614, the CPU 21 sets the acquired process date and time in the device information, and stores the device information.

As described above, in this exemplary embodiment, an orderer and an order receiver are capable of checking the operational status and the schedule of a printer. Therefore, the workload involved in checking the throughput of a printing process and the operational status of each company may be reduced when an order is placed and received for production of printed matter, as compared with a case where the throughput of the printing process and the operational status of each company are checked between the orderer and the order receiver.

The configuration of the printed-matter order placing-receiving server 10 described in the above exemplary embodiment is an example, and may be changed in accordance with the circumstances within the scope of the present disclosure.

The flow of the process according to the program described in the above exemplary embodiment is an example. An unnecessary step or steps may be deleted, a new step or steps may be added, or the processing sequence may be changed within the scope of the present disclosure.

In the exemplary embodiments above, the term “processor” refers to hardware in a broad sense. Examples of the processor include general processors (e.g., CPU: Central Processing Unit) and dedicated processors (e.g., GPU: Graphics Processing Unit, ASIC: Application Integrated Circuit, FPGA: Field Programmable Gate Array, and programmable logic device).

In the exemplary embodiments above, the term “processor” is broad enough to encompass one processor or plural processors in collaboration which are located physically apart from each other but may work cooperatively. The order of operations of the processor is not limited to one described in the exemplary embodiments above, and may be changed.

Furthermore, in the above exemplary embodiments, the information processing program is preliminarily stored (installed) in the storage unit 24. Alternatively, the program may be provided by being stored in a storage medium, such as a compact disc read-only memory (CD-ROM), a digital versatile disc read-only memory (DVD-ROM), or a universal serial bus (USB) memory. As another alternative, the program may be downloaded from an external device via a network.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The exemplary embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a processor configured to
store received-order information indicating that production of printed matter is acceptable and containing device information used for producing the printed matter,
receive order information with respect to a process for producing the printed matter,
identify the received-order information indicating that the production of the printed matter is acceptable from the stored received-order information by using the printed matter indicated in the order information as a search condition, and
associate the order information with at least one device corresponding to the device information associated with the identified received-order information.

2. The information processing apparatus according to claim 1, wherein the processor derives an operational status of the at least one device associated with the order information and generates display information for displaying the derived operational status.

3. The information processing apparatus according to claim 2, wherein the processor generates the display information for displaying the operational status including the operational status of the at least one device before the production of the printed matter indicated in the order information is accepted and the operational status of the at least one device when the production of the printed matter indicated in the order information is accepted.

4. The information processing apparatus according to claim 3, wherein the processor derives an amount of change in the operational status of the at least one device from the operational status of the at least one device before the production of the printed matter is accepted and the operational status of the at least one device after the production of the printed matter is accepted, and identifies the order information corresponding to the designated amount of change.

5. The information processing apparatus according to claim 2, wherein the processor displays the operational status of the at least one device for each step to be executed by the at least one device in the production of the printed matter.

6. The information processing apparatus according to claim 3, wherein the processor displays the operational status of the at least one device for each step to be executed by the at least one device in the production of the printed matter.

7. The information processing apparatus according to claim 4, wherein the processor displays the operational status of the at least one device for each step to be executed by the at least one device in the production of the printed matter.

8. The information processing apparatus according to claim 2, wherein the at least one device includes a plurality of devices, and
wherein the processor further acquires an authority level for performing control for displaying the operational status for each device, and generates the display information for displaying the operational status of each device in accordance with the authority level.

9. The information processing apparatus according to claim 3, wherein the at least one device includes a plurality of devices, and
wherein the processor further acquires an authority level for performing control for displaying the operational status for each device, and generates the display information for displaying the operational status of each device in accordance with the authority level.

10. The information processing apparatus according to claim 4, wherein the at least one device includes a plurality of devices, and
wherein the processor further acquires an authority level for performing control for displaying the operational status for each device, and generates the display information for displaying the operational status of each device in accordance with the authority level.

11. The information processing apparatus according to claim 5, wherein the at least one device includes a plurality of devices, and
wherein the processor further acquires an authority level for performing control for displaying the operational status for each device, and generates the display information for displaying the operational status of each device in accordance with the authority level.

12. The information processing apparatus according to claim 6, wherein the at least one device includes a plurality of devices, and
wherein the processor further acquires an authority level for performing control for displaying the operational status for each device, and generates the display information for displaying the operational status of each device in accordance with the authority level.

13. The information processing apparatus according to claim 7, wherein the at least one device includes a plurality of devices, and
wherein the processor further acquires an authority level for performing control for displaying the operational status for each device, and generates the display information for displaying the operational status of each device in accordance with the authority level.

14. The information processing apparatus according to claim 1, wherein, when the processor associates the order information with the device information related to the received-order information, the processor searches for the received-order information and accepts whether or not the received-order information is to be selected.

15. The information processing apparatus according to claim 2, wherein, when the processor associates the order information with the device information related to the received-order information, the processor searches for the received-order information and accepts whether or not the received-order information is to be selected.

16. The information processing apparatus according to claim 3, wherein, when the processor associates the order information with the device information related to the received-order information, the processor searches for the received-order information and accepts whether or not the received-order information is to be selected.

17. The information processing apparatus according to claim 4, wherein, when the processor associates the order information with the device information related to the received-order information, the processor searches for the received-order information and accepts whether or not the received-order information is to be selected.

18. The information processing apparatus according to claim 1,
wherein the processor is further configured to
store the order information,
receive the received-order information and identify the order information indicating an order of the printed matter that is producible from the stored order information by using the printed matter indicated in the received-order information as the search condition, and
associate the identified order information with the at least one device corresponding to the device information associated with the received-order information.

19. The information processing apparatus according to claim 18, wherein, when the processor associates the order information with the device information related to the received-order information, the processor searches for the order information and accepts whether or not the order information is to be selected.

20. A non-transitory computer readable medium storing a program causing a computer to execute a process, the process comprising:
storing received-order information indicating that production of printed matter is acceptable and containing device information used for producing the printed matter;
receiving order information with respect to a process for producing the printed matter;
identifying the received-order information indicating that the production of the printed matter is acceptable from the stored received-order information by using the printed matter indicated in the order information as a search condition; and
associating the order information with at least one device corresponding to the device information associated with the identified received-order information.
